(19) United States
(12) Patent Application Publication
(10) Pub. No.: US 2011/0095880 A1
(43) Pub. Date: Apr. 28, 2011

(54) Brake Pipe Charge Monitor System and Method

(75) Inventor: Edward W. Gaughan, Greensburg, PA (US)

(73) Assignee: WABTEC HOLDING CORP., Wilmerding, PA (US)

(21) Appl. No.: 12/910,017

(22) Filed: Oct. 22, 2010

Related U.S. Application Data
(60) Provisional application No. 61/253,993, filed on Oct. 22, 2009.

(51) Int. Cl. B60Q 1/00

(52) U.S. Cl. 340/453

(57) ABSTRACT

A method for establishing a predicted brake pipe pressure gradient is disclosed and generally includes installing an end-of-train unit on a railcar of an active train for sensing brake pipe pressure; installing a head-end-unit on a locomotive in the active train; transmitting brake pipe pressure data from the end-of-train unit to the head-end-unit; calculating predictive brake pipe pressure gradient between a first end of the brake pipe at the locomotive and a second end at the railcar; and displaying the predictive brake pipe pressure gradient for an observer in the locomotive.

### CROSS REFERENCE TO RELATED APPLICATIONS

This application is based on U.S. Provisional Patent Application No. 61/253,993, filed Oct. 22, 2009, on which priority of this patent application is based and which is hereby incorporated by reference in its entirety.

### BACKGROUND OF THE INVENTION

1. Field of the Invention

This disclosure relates generally to the field of train control systems and, more specifically, to a locomotive display showing a predicted brake pipe pressure gradient in the train.

2. Description of Related Art

Present day freight trains have a brake pipe that runs through each car and is coupled therebetween so as to extend continuously the length of the train. The brake pipe is charged with compressed air typically at the head end by a compressor on the locomotive. The compressed air not only provides the pneumatic brake force at the respective cars, but also serves as a communication link via which the car's brakes are controlled from the locomotive by increasing and decreasing the brake pipe pressure.

When a train brake pipe is fully charged to the pressure setting of the locomotive brake valve device, a natural pressure gradient typically exists in the brake pipe due to leakage and the pressure maintaining function of the brake valve. Assuming the locomotive brake valve is set to charge brake pipe to 90 psi, the pressure at each car from front to rear of the train will experience a slightly lower pressure due to leakage and fluid flow resistance as the pressure maintaining brake valve attempts to maintain the leakage. The brake pipe pressure will gradually rise from front to back in seeking the natural pressure gradient consistent with the application of brake pipe pressure at the locomotive.

The tests to determine actual pressure drop along a brake pipe takes a great deal of time and resources. A brake pipe leakage test can determine the actual pressure drop (gradient) from the lead brake pipe to the rear brake pipe. The brake pipe leakage test is typically conducted by charging the air brake system with a pressure regulator to the pressure at which the train will be operated. The brake pipe is considered to be charged when the pressure at the end of the train is within 15 psi of the pressure at which the train will be operated, but not less than 75 psi. A pressure gauge or end-of-train (EOT) unit is used to measure the pressure at the rear of the train. If the brake pipe leakage is less than 5 psi per minute, the brake pipe leakage test is considered to have been passed. Generally, in order to perform a brake pipe leakage test, two operators are required. The first operator is required at a first end of the brake pipe in order to operate the pressure regulator that adjusts the pressure within the chamber to the pressure at which the train will be operated. A second operator is required at the second end of the brake pipe in order to take a pressure reading using a pressure gauge at the end of the brake pipe opposite the pressure regulator. The operator at the end of the brake pipe takes a measurement of the pressure at the end of the brake pipe in order to ensure that it is within 15 psi of the predetermined level and not less than 75 psi.

A second test is the Air Flow Method (AFM) Test. When a locomotive is equipped with a 26-L brake valve or equivalent pressure maintaining locomotive brake valve, a railroad may use the AFM Test as an alternate to the brake pipe leakage test. To perform the AFM Test, the air brake system is charged to the pressure at which the train will operate. When the pressure at the rear of the train is within 15 psi of the pressure at which the train will be operated and not less than 75 psi, as indicated by an accurate gauge or EOT device at the rear end of train, an operator can measure air flow as indicated using a calibrated AFM Test indicator. The measured air flow cannot exceed 60 cubic feet per minute (CFM).

When the train includes an EOT unit, the EOT unit is positioned at the end of the train opposite the location of the pressure regulator and adapted for obtaining a pressure measurement from the end of the brake pipe. The EOT unit is also able to communicate this measurement to an operator in the locomotive controlling the pressure regulator, such as to allow the latter to monitor the brake pipe pressure at the end of the train.

### SUMMARY OF THE INVENTION

It is an objective of the present invention to provide a method of predicting a natural pressure gradient for a railroad train brake pipe extending from a head end device to an end of train device. The method includes inputting brake pipe threshold values for a train, initially charging the brake pipe from the head end unit. Next, the method includes reporting end of train brake pipe data. Then the method includes determining pressure gradient by comparing end of train brake pipe data to threshold values after a set period, and alerting only when the train's predicted gradient will not be compliant. The set period can be when either the car with the end of train device reaches a first pressure level or after a time duration.

The method also includes developing the brake pipe threshold values from reported measurements of a reference train comprising final natural gradient, air flow measurements and rate of brake pipe pressure increase measurements. The reference train operates with the same configuration as the operating train. The end of train device comprises an air flow sensor or a rate of brake pipe pressure sensor. A train can be found compliant if the predictive brake pipe pressure predicted gradient will be more than 15 psi.

The method further includes monitoring and reporting to the head end device the rate of increase in brake pipe pressure at the end of train device. The train will be compliant if the rate of increase is greater than the threshold value, or if the threshold rate of increase is 0.7 psi/minute. The EOT device monitors and reports to the head end device the air flow at the end of train device. The train will be compliant if the air flow rate is less than a threshold rate that can be an air flow rate is less than 70 SCFM. In addition, the train can be compliant if either air flow rate is less than a threshold or the rate of increase is greater than a threshold. The end of train device can be on any car, but in one embodiment is on the last car of the train.

The present invention alerts a user in a number of ways, including sending an email, sending an SMS message, sending a voice message, providing an audible signal, providing a display of the determined pressure gradient results, providing data displayable in a handheld computerized device or cellular telephone.

The present invention also includes a gradient predicting apparatus. The gradient predicting apparatus includes a train having a natural pressure gradient for a train brake pipe, a head end device, an end of train device with brake sensing, and software. The gradient predicting software controls a computer to receive brake pipe threshold values for a train, charge the brake pipe from the head end unit, report end of train device data on the brake pipe, determines pressure gradient by comparing end of train data to threshold values when the car with the end of train device reaches a first pressure level and alerts when the train's predicted gradient will not be compliant.

The brake pipe gradient predicting apparatus can develop the brake pipe threshold values from reported measurements of a reference train comprising final natural gradient, air flow measurements and rate of brake pipe pressure increase measurements. A train is compliant if the predictive brake pipe pressure predicted gradient will be more than 15 psi., and if the air flow rate is less than threshold or the rate of increase is greater than threshold. The apparatus can send alerts via an email, a SMS message, a voice message, providing an audible signal, providing a display of the determined pressure gradient results, providing data displayable in a handheld computerized device or cellular telephone.

It is an objective of the present invention to further provide a brake pipe gradient predicting system. The system includes a train having a natural pressure gradient between a locomotive and a last car. The train locomotive includes a head end device and a last car has an end of train device with brake sensing and transmitting. The gradient predicting system can include a means for inputting brake pipe threshold values for a train comprising stored threshold values for a reference train having configurations relevant to the active train, a means for reporting end of train device data on the brake pipe, a means for determining pressure gradient by comparing end of train data to threshold values when the car with the end of train device reaches a first pressure level and an alerting means for notifying an operator when the train's predicted gradient will not be compliant.

### BRIEF DESCRIPTION OF THE DRAWINGS

FIG. 1 is a graph of the rate of increase of the last car brake pipe pressure at different times.

FIG. 2 is a block diagram of a brake pipe charge monitor system for developing and displaying a predictive brake pipe gradient.

FIG. 3 is a graph depicting brake pipe pressure gradient for time example trains over a period of time.

FIG. 4 is a graph of the pressure in a brake pipe of three example trains over a period of time.

FIG. 5 is a graph showing the brake pipe sensed flow for psi levels of the last car brake pipe pressure of three example trains.

FIG. 6 is an exemplary display depicting predicted brake pipe gradient utilizing the system of FIG. 1.

FIG. 7 is a flowchart outlining method steps associated with the system of FIG. 1 for developing and displaying a predictive brake pipe gradient.

### DESCRIPTION OF THE PREFERRED EMBODIMENTS

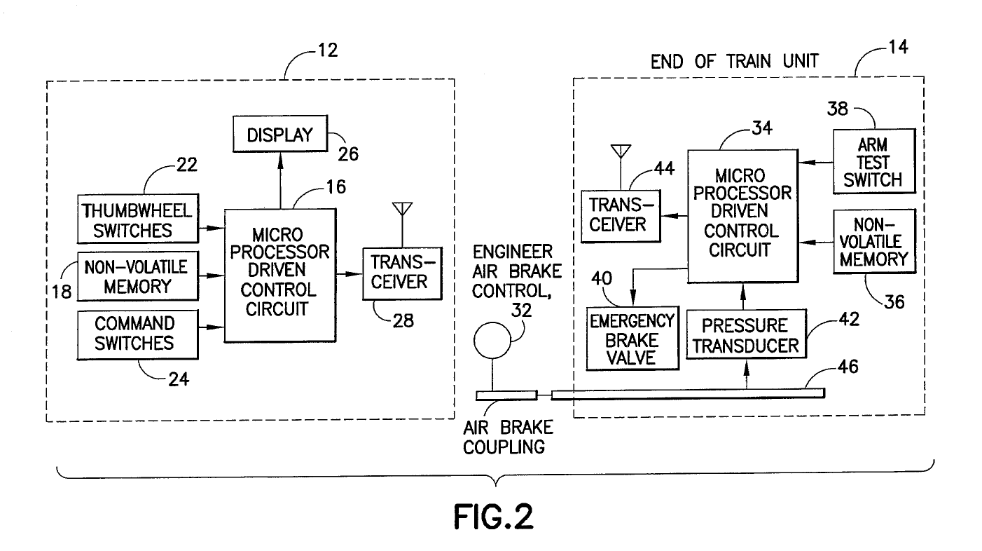

Referring to FIG. 2, brake pipe 46 charge monitor system 10 includes an end-of-train (EOT) unit 14, a head-end-unit (HEU) 12, and a display 26 for showing a locomotive operator a predicted brake pipe 46 gradient along a train. The EOT unit 14 can be mounted to the last railcar in the train. The EOT unit 14 is coupled to the rear of brake pipe 46 at the last railcar by means of a hose and a glandhand. The EOT unit 14 transmits, by radio signals, to the HEU 12 data pertaining to the pressure in the brake pipe 46. To accomplish this, the EOT unit 14 includes a pressure transducer 42 to monitor brake pipe 46 pressure, a microprocessor unit 34 to control the overall operation, and a transmitter 44 that the microprocessor unit 34 utilizes to transmit the last railcar data.

The pressure transducer 42 of EOT unit 14 can further include flow pressure sensing, which can monitor a condition of brake pipe 46 fluid pressure, such as rate of increase of fluid pressure in the brake pipe 46. The HEU 12 in the locomotive includes primary display 26, transceiver 28 to receive transmissions from the EOT unit 14, microprocessor unit 16, and non-volatile memory 18. The HEU 12 is coupled to the front of brake pipe 46 at the locomotive. The HEU 12 can measure the flow rate being placed into brake pipe 46 by the locomotive.

The change in pressure in the EOT unit 14 can be detected by the transducer 42. Brake pipe 46 pressure at the end of the train can be checked using the pressure value measured at transducer 42 of EOT unit 14 and can include memory or storage to store variable information, such as brake pipe 46 pressure or the rate of change of either the EOT unit 14 or the HEU 12. In addition, the information can be transmitted to additional devices having storage, memory, and microprocessors connected to the EOT 14 or HEU 12. The connection can be implemented using direct or wireless connections as known to one skilled in the art. Secondary devices can include handheld devices on which the invention or a modification of the invention, adapted to such devices, can operate. To store data in the HEU 12, data can be transmitted to the microprocessor 16 and memory 18 in HEU 12 from microprocessor unit 34 in EOT unit 14 via transceivers 28, 44.

The microprocessor unit 34 in EOT unit 14 can include programming instructions to process received readings to correlate gradient curves and calculate changes in pressure. The information calculated on EOT unit 14 can be transferred to HEU 12. In addition, raw data can be transferred to HEU 12 where the programming instructions can reside.

The non-volatile memory 36 of EOT unit 14 can store a brake pipe 46 charge monitor program operable on the microprocessor unit 34 to calculate and store a brake pipe 46 gradient. The EOT unit 14 can store results data in memory 36.

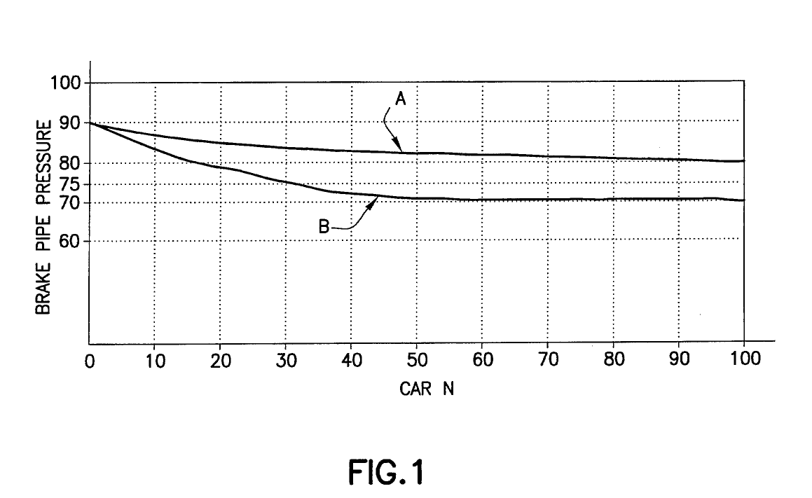

In one embodiment, sensed flow must be below a threshold level when the EOT unit 14 brake pipe 46 pressure reaches 65 psi. Sensed flow is dependent on leakage when the brake pipe 46 has many leaks, and flow measured in Standard Cubic Feet per Minute (SCFM) will remain high because higher flow is needed to account for more leaks. Fewer holes mean that leakage is acceptable. Similarly, the rate of increase of brake pipe 46 pressure shows that the pressure is still increasing. In one example, a compliant train, in this case having one-hundred-fifty 50 ft. cars, as represented by curve A of FIG. 1, at car 100, the brake pipe 46 pressure is only 80 psi, when fully charged, a 10 psi gradient exists from car 1 to car 100. Alternatively, in FIG. 1, curve B represents a non-compliant train, the brake pipe 46 pressure of a train when charged to 90 psi at the lead locomotive. The natural gradient of this curve B shows that at car 100, the brake pipe 46 pressure is only 70 psi when fully charged, a 20 psi gradient from car 1 to car 100. Each train can have a different natural gradient as a result of the inevitable leakage of compressed air at the hose couplings that connect the brake pipe 46 between cars or at other sources, and due to brake pipe 46 pressure flow resistance encountered in maintaining this leakage or other variables. If non-compliant, additional, timely maintenance must be performed.

To predict if a train is going to have a compliant gradient as in curve A or a non-compliant gradient as in curve B, information about a train can be captured and compared. For prediction, an estimate can be based on the assumption that a natural gradient is similar in trains having similar configurations. One skilled in the art will recognize that additional train data will provide convergence on the ideal outcome.

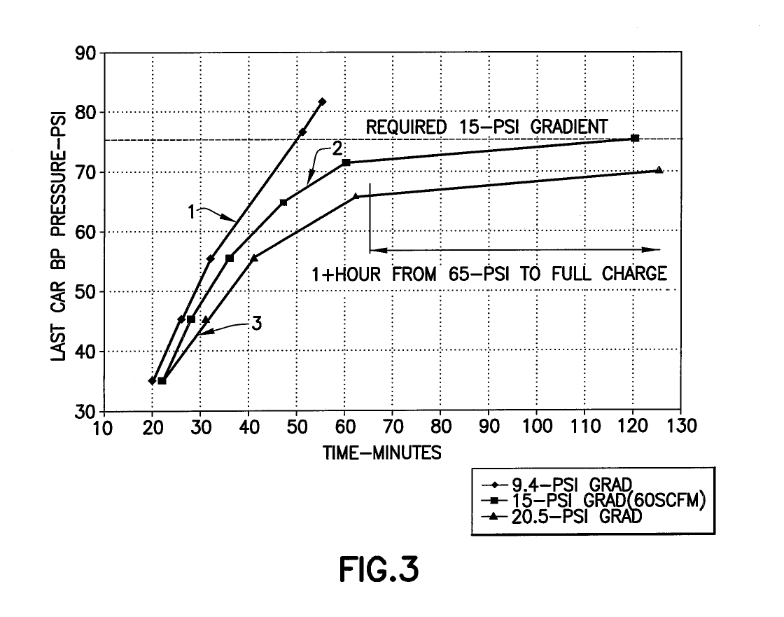

With reference to FIG. 3, brake pipe 46 state of charge for a 130 minute period for three different exemplary trains 1, trains 2, and trains 3 is shown. For illustration, each train represented has a length of 7,500 feet when having one-hundred-fifty 50 ft. cars. The graph shows the enormous discrepancy in duration for reaching a full charge, and shows train 3, which fails to comply. In the graph, train 1 starts out with a last car psi of 35 psi and reaches 81 psi in approximately 35 minutes. Train 1 charges from 65 psi to 81 psi in approximately 15 minutes. Train 2 takes over an hour to charge from 65 psi to 75 psi. Train 3 never reaches the threshold, topping out at approximately 70 psi. The three trains can be used to develop threshold values. The graph also shows that predicting the gradient when the train's rear car reaches the 65 psi level could have saved up to an hour because maintenance can be provided on the non-compliant train before it reached full charge.

Based on the curves in FIG. 3, it can be seen that trains 1 and 2 are compliant and train 3 is non-compliant. From flow information for trains 1-3, the threshold values for air flow can be calculated and used for predicting gradient of similar trains.

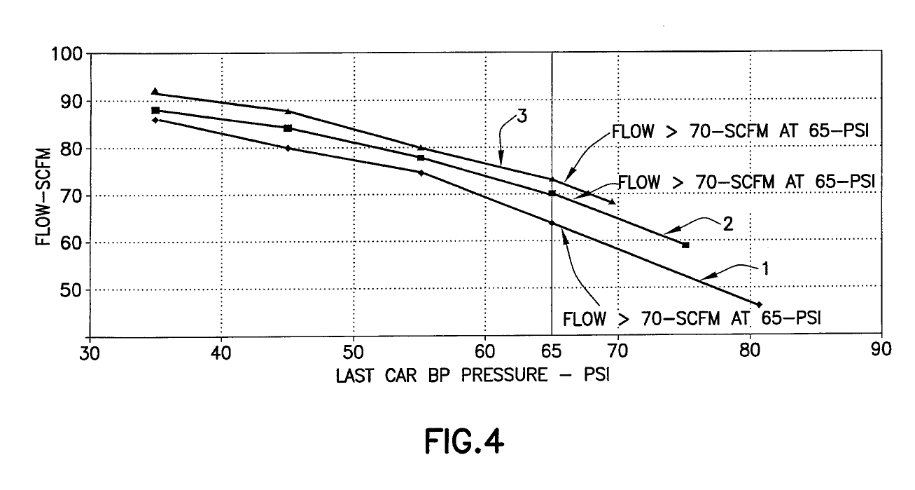

With reference to FIG. 4, the graph shows the brake pipe 46 sensed flow for the last car of trains 1-3. When the flow rate is above 70, standard cubic feet per minute (SCFM) at 65 psi, comparable to non-compliant train 3, this is indication that a train will not reach a target gradient because the air flow is indicating too much leakage. A compliant train, however, can have a flow rate at or below 70 SCFM when their respective rear cars are at 65 psi. The two compliant trains 1 and 2 reach full capacity having a flow rate below 70 SCFM, and since train 3 is above 70 SCFM at 65 psi, 70 SCFM can be used for a threshold value for this train configuration.

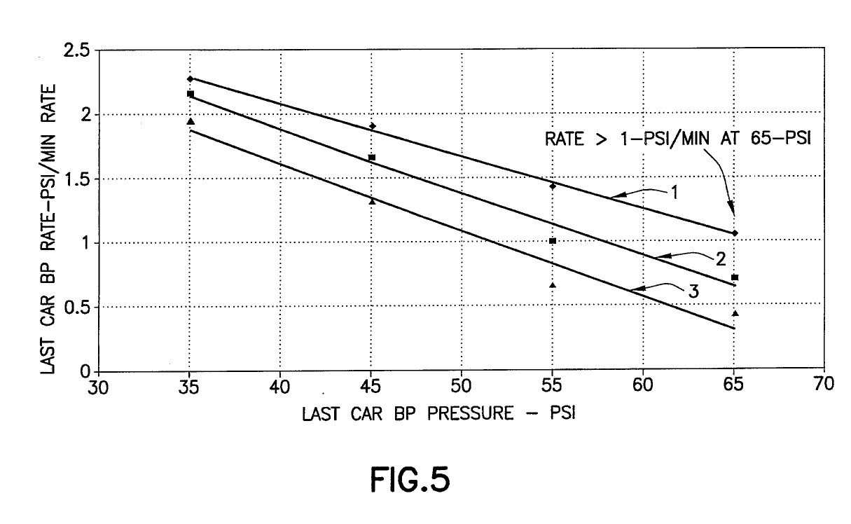

Similarly, brake pipe 46 increase for the trains 1-3 can be used to determine threshold rate. With reference to FIG. 5, the graph of the rate of increase of the last car brake pipe 46 pressure for trains 1-3. The rate of increase of brake pipe 46 pressure in the last car of a train can be used as a threshold level. For example, since the graph shows compliant train 2 at 0.7 psi/min when it reaches 65 psi and train 3 below 0.7 psi/min, a level of less than 0.7 psi/min increase or below when the last car is at 65 psi can be utilized as a threshold value.

After the threshold values are determined, they can be used to generate warnings, display of status, or predict gradient. Threshold values can be stored in EOT unit 14 or HEU 12 memory. Software programming instructions can be loaded and executed by microprocessor unit 16. The software compares the rate of pressure increase in the current train to threshold values for train consists of similar length. The software can alternatively compare the flow rate at a different psi level for train consists of similar length to make a similar determination. The display 26 can show the predicted gradient in the locomotive, aiding an operator to determine whether the predicted gradient is compliant and make the proper corrective actions if the gradient is outside the proper range. Rather than waiting for the train to achieve the stabilized state of charge, alternative actions may be taken immediately to repair the brake pipe 46.

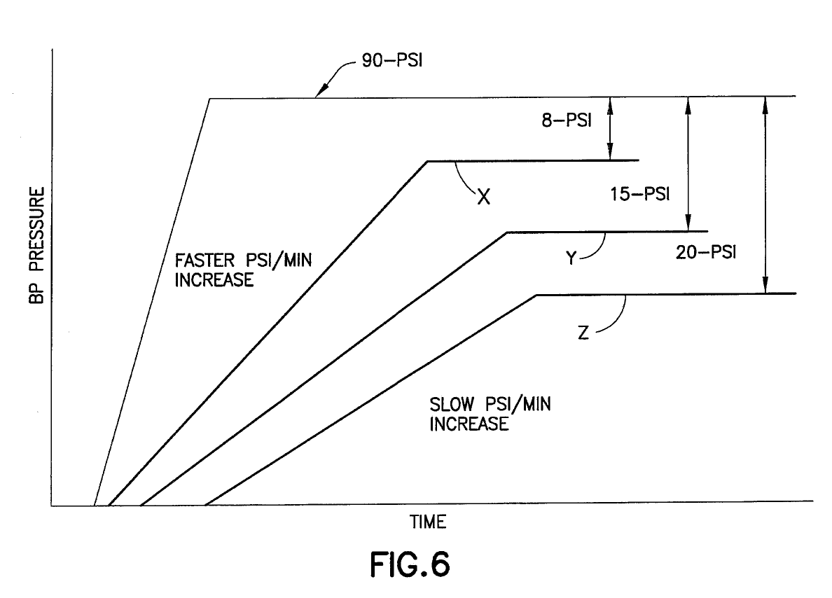

With reference to FIG. 6, an exemplary graphical output is illustrated to show predicted gradient of a train indicates the pressure increase in the brake pipe 46 over time (minutes). The graphical output is not meant to be limiting, as the display capabilities of locomotives is a factor in the type of display one skilled in the art would consider applicable. A graphical output of FIG. 6 can be displayed on display 26 as in FIG. 2, or alternatively, can be transmitted to a remote display device having a connection to the train. The brake pipe 46 is considered to be charged when the pressure at the end of the train is within 15 psi of the pressure at which the train is operated (as shown, 90 psi), for example, curves X and Y. If the predicted gradient is more than 15 psi as shown with curve Z, the operator may perform further maintenance tasks to fix the brake pipe 46. The flow rate can also be a feature in the display 26. In another embodiment (not shown), colors can be used to signal predicted status. For example, red, yellow, and blue, where blue is compliant, red is non-compliant, yellow is not enough information, showing one of the curves X, Y, or Z with a status color.

In another embodiment, other devices, such as handheld devices can be used. Also, the graphical layout can take other forms, such as an installation bar that can highlight progress. In addition to textual or graphical output alerting a user of gradient prediction, the software can be configured to activate an alarm, send an email, SMS message, or other types of alerts to indicate prediction. However, it is envisioned that other outputs known to one of ordinary skill in the art could be used.

The invention further includes a method for predicting gradient in a train. In order to perform the method, an EOT unit 14 as shown in FIG. 2, can be installed in the last railcar of an active train. The EOT unit 14 can connect to a rear portion of the brake pipe 46 and can be operative to sense brake pipe 46 information, such as the rate of pressure increase of the last car brake pipe 46. An HEU 12 can be provided in the locomotive to sense air flow in the brake pipe and communication can be operative between the HEU 12 and the EOT unit 14. Either the HEU 12 or the EOT unit 14 can be operated to input threshold values determined by measuring a train and determining the length of the brake pipe 46 and also measuring the brake pipe 46 information as the train brake pipe 46 as pressure is applied to the train inside the train's brake pipe 46. The EOT unit 14 can include a sensor to capture the information and can store or pass to the HEU 12. Software on the EOT unit 14, HEU 12, or on a connected device can utilize threshold values and train data to predict gradient of train brake pipe 46. Threshold values can be manually entered, downloaded, or calculated from train data entered into the system.

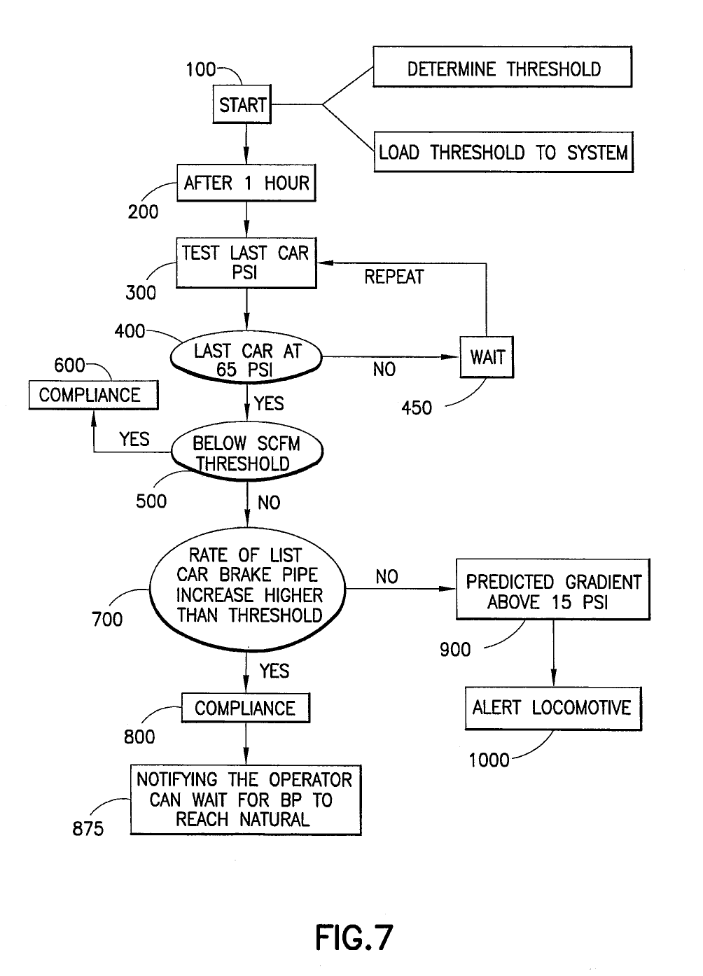

With reference to FIG. 7, a flow chart showing the steps for determining a predicted gradient begins at block 100 by activating air flow into the brake pipe 46. Block 100 occurs after determining threshold values has been performed. Also, the threshold values are inputted into the brake pipe 46 charge monitor system, either manually or through an application interface. Next, at a predetermined time, for example, one hour in duration, at block 200 the system activates to determine a predicted gradient. The system can, alternatively, continuously monitor the brake pipe 46 and track progress, information, and store in memory, and either pass continuously to the HEU 12 or retain in memory until the method queries the EOT unit 14 for the stored information.

With continued reference to FIG. 7, at block 300, the last car test is performed and the psi level is captured. At block 400, the system determines if the last car is at 65 psi. If the system is not at 65 psi, operation stops at block 450 until it repeats at block 300. Software can provide an interface to receive indicators, such as the period before the system resumes after a low psi. At block 400, if the last car is determined to be at or above 65 psi, then the air flow value is tested at block 500. The measured air flow passing through the brake pipe 46 in the last car of the train is measured and compared to a threshold value at block 500. If the actual air flow matches, or below, the threshold value is then compliant at block 600. In the train described in FIGS. 3-5, if the air flow is below 70 SCFM, a train passes. If the air flow rate is not within the threshold value, then the train does not pass on this criteria. Next, at block 700, the rate of the actual last car brake pipe 46 increase value is compared against a rate of last car brake pipe 46 increase threshold value. If the actual brake pipe 46 increase is higher than the threshold value, then the brake pipe 46 is determined to be compliant and, therefore, the predicted gradient is in range, below 15 psi at block 850. At block 875, notification can be transmitted to the train locomotive, displayed, and the operator can wait for the brake pipe 46 to reach its natural gradient. Returning to block 700, if the brake pipe 46 is higher than the threshold value, then the train is non-compliant at block 900. Based on the non-compliant predicted gradient above 15 psi, at block 1000 the operator is alerted. The alert can be displayed graphically on HEU 12, EOT unit 14, or a connected device by an alarm mechanism, or some other type of electronic alert capable to notify the operator that the train will not reach an operable gradient and, therefore, maintenance steps should be taken to remedy the brake pipe 46 in order to achieve compliance.

Based on the foregoing specification, the methods described may be implemented using computer programming or engineering techniques including computer software, firmware, hardware, or any combination or subset thereof, wherein the technical effect is to provide a locomotive control system with a diagnostic display of predicted gradient. Any such resulting program, having computer-readable code means, may be embodied or provided within one or more computer-readable media, thereby making a computer program product, (i.e., an article of manufacture). The computer readable media may be, for instance, a fixed (hard) drive, diskette, optical disk, magnetic tape, semiconductor memory, such as read-only memory (ROM), etc., or any transmitting/receiving medium, such as the Internet or other communication network or link. The article of manufacture containing the computer code may be made and/or used by executing the code directly from one medium, by copying the code from one medium to another medium, or by transmitting the code over a network.

One skilled in the art will easily be able to combine the software created as described with appropriate general purpose or special purpose computer hardware, such as a microprocessor to create a computer system or computer sub-system embodying the method of the invention. An apparatus for making, using, or selling the invention may be one or more processing systems including, but not limited to, the CPU, memory, storage devices, communication links, and devices, servers, I/O devices, or any sub-components of one or more processing systems, including software, firmware, hardware, or any combination or subset thereof, which embody the invention.

While the embodiments of system, devices, and methods described hereinabove may be used to implement a locomotive display showing a predicted brake pipe 46 pressure gradient in a train, those skilled in the art may make modifications and alterations to these embodiments without departing from the scope and spirit of the invention. Accordingly, the foregoing description is intended to be illustrative rather than restrictive.

The invention claimed is:

1. A method of predicting a natural pressure gradient for a railroad train brake pipe extending from a head end device to an end of train device, the method comprising:
inputting brake pipe threshold values for a train;
initially charging the brake pipe from the head end unit;
reporting end of train brake pipe data;
determining pressure gradient by comparing end of train brake pipe data to threshold values after a set period; and
alerting when the train's predicted brake pipe pressure gradient is not compliant.

2. The method of claim 1, wherein said set period is when either the car with the end of train device reaches a first pressure level or after a time duration.

3. The method according to claim 1, further comprising developing said brake pipe threshold values from reported measurements of a reference train comprising final natural gradient, air flow measurements, and rate of brake pipe pressure increase measurements.

4. The method according to claim 3, wherein said reference train operates with the same configuration as the operating train.

5. The method according to claim 1, wherein said end of train device comprises an air flow sensor or a rate of brake pipe pressure sensor.

6. A method as claimed in claim 3, wherein a train is compliant if the predicted brake pipe pressure gradient is more than 15 psi.

7. The method according to claim 3, further comprising monitoring and reporting to the head end device the rate of increase in brake pipe pressure at the end of train device.

8. The method according to claim 7, wherein the train will be compliant if the rate of increase is greater than the threshold value.

9. The method according to claim 8, wherein threshold rate of increase is 0.7 psi/minute.

10. The method according to claim 1, further comprising monitoring and reporting to the head end device the air flow at the end of train device.

11. The method according to claim 10, wherein the train will be compliant if the air flow rate is less than a threshold rate.

12. The method according to claim 11, wherein the threshold air flow rate is less than 70 SCFM.

13. The method according to claim 6, wherein the train is compliant if the air flow rate is less than the threshold or the rate of increase is greater than the threshold.

14. The method according to claim 1, wherein the end of train device is on the last car of the train.

15. The method according to claim 1, wherein alerting comprises one of: sending an email, sending an SMS message; sending a voice message; providing an audible signal; providing a display of the determined pressure gradient results; and providing data displayable in a handheld computerized device or cellular telephone.

16. A brake pipe gradient predicting apparatus including a train having a natural pressure gradient for a train brake pipe, a head end device, an end of train device with brake sensing, the gradient predicting comprising software which:
receives brake pipe threshold values for a train;
charges the brake pipe from the head end unit;
reports end of train device data on the brake pipe;
determines pressure gradient by comparing end of train data to threshold values when the car with the end of train device reaches a first pressure level; and
alerts when the train's predicted gradient is not compliant.

17. The apparatus according to claim 16, further comprising developing said brake pipe threshold values from reported measurements of a reference train comprising final natural gradient, air flow measurements, and rate of brake pipe pressure increase measurements.

18. The apparatus according to claim 17, wherein a train is compliant if the predicted brake pipe pressure predicted gradient is more than 15 psi.

19. The apparatus according to claim 18, wherein the train is compliant if the air flow rate is less than the threshold or the rate of increase is greater than the threshold.

20. The apparatus according to claim 19, wherein alerting comprises one of: sending an email, sending an SMS message, sending a voice message, providing an audible signal, providing a display of the determined pressure gradient results, providing data displayable in a handheld computerized device or cellular telephone.

21. A brake pipe gradient predicting system including a train having a natural pressure gradient between a locomotive and a last car, said train locomotive having a head end device and a last car having an end of train device with brake sensing and transmitting, the gradient predicting system comprising:
means for inputting brake pipe threshold values for a train comprising stored threshold values for a reference train having configurations relevant to the active train;
means for reporting end of train device data on the brake pipe;
means for determining pressure gradient by comparing end of train data to threshold values when the car with the end of train device reaches a first pressure level; and
alerting means for notifying an operator when the train's predicted gradient will not be compliant.
